(19) United States
(12) Patent Application Publication
(10) Pub. No.: US 2006/0180662 A1
(43) Pub. Date: Aug. 17, 2006

(54) Check-out system

(75) Inventor: Luigino Paolino Giovanni Pirruccio, Amersfoort (NL)

Correspondence Address: TROUTMAN SANDERS LLP, 600 PEACHTREE STREET , NE, ATLANTA, GA, 30308, US

(73) Assignee: Scangineers B.V., GE Asten (NL)

(21) Appl. No.: 10/520,460

(22) PCT Filed: Sep. 17, 2002
(86) PCT No.: PCT/NL02/00593

§ 371 Date: Jun. 15, 2005

(30) Foreign Application Priority Data
Jul. 12, 2002 (NL) 1021058

(51) Int. Cl. G06K 15/00

(52) U.S. Cl. 235/383

(57) ABSTRACT

A check-out system (1) with an improved security against unauthorized taking away of articles is described. A customer inputs an identification code of an article, for instance by a scanner. The identification is checked by a weight measurement, and possibly with further measuring methods. The articles are conveyed to a shielded collecting space (20). When the customer is ready, an access barrier (21) of the collecting space (20) is closed. The customer can now pay, for instance with his PIN card. He receives a release-code (62) on the cash slip (61). This code is inputted on an input apparatus (23) which is arranged close to the collecting space (20), after which a security (22) of collecting space (20) is lifted and the customer can take his articles away from the collecting space.

The present invention relates to a check-out system, usable for application in for instance a supermarket, where often multiple customers are present at the same time, and wherein each customer usually wants to check-out multiple purchases. The customer has those purchases collected in a shopping basket or shopping cart, and arrives at a check-out. Traditionally, this check-out is manned, i.e. personnel (a cashier) is present. In conventional check-out systems, this cashier will enter the price of each individual article into a cash register. Nowadays, the articles are usually provided with a barcode, and the more modern check-out systems are provided with a barcode reader which is connected to the cash register; in the case of this type of systems, the cashier will pick up each article, and will move this article through the viewing field of the barcode reader, with the barcode directed towards the barcode reader.

The necessary presence of serving personnel (cashier) is a disadvantage of the known check-out systems. In the case of a check-out system, the personnel costs form a substantial part of the exploitation costs. Further, space must be kept free for the serving personnel, which implies that adjacent check-out systems must be placed at relatively large mutual distance; conversely, in the case of a certain amount of mutual space, this means a limitation of the total number of check-out systems which can be arranged next to each other at a location. It has appeared that customers have a growing need to check-out the shoppings completely on their own and with a waiting time as short as possible. This waiting time can be reduced by placing multiple check-out systems. Therefore, check-out systems have been developed which can operate without the necessary presence of a cashier. Those systems will hereinafter be indicated with the phrase “automatic check-out system”.

In the case of a check-out system, in principle three operations need to be conducted. In the first place, the identity of the articles must be communicated to the check-out system. In the second place, the articles must be collected and stored, for instance in a bag, a box or the like. In the third place, one must pay.

In the case of a manned check-out, it is the cashier who performs the operations associated with identifying the articles. Usually, the customer has previously placed his shoppings on an entry belt, and during the processing by the cashier, the customer is located “downstream” of the cashier, such that the customer, as soon as the cashier has processed an article, can pick up this article and put it away. Shortly after the cashier is ready with entering the articles, the customer is also ready with putting the articles away, and it is possible to pay. Thus, manned check-out systems have the property that identification of articles and putting articles away can largely be done in parallel, and that the identified articles are under supervision almost continuously. On the other hand, manned check-out systems have the property that the system is blocked for further identification of the articles of a next customer until the previous customer has paid.

Unmanned, automatic check-out systems are known in which customers perform the said operations themselves. Usually, these are systems wherein the barcodes of individual articles must be provided to a scanner by hand, either a hand-held scanner or a fixedly arranged scanner. However, a human being can not do two things at the same time. A problem in this respect is, therefore, to combine the storing and paying of the articles with the scanning in an efficient manner. Further, the present invention aims to provide a check-out system wherein mistakes, when putting away, are avoided.

After scanning, an article is located at the scan location in certain systems, and is usually still held by the customer at that moment. Customers now tend to directly put away a scanned article. Often, this even is the intention, and there is no space for collecting the scanned articles. It is then a disadvantage that the scan apparatus is used relatively inefficiently because one is alternatingly scanning and putting away. A check-out system then is occupied by the customer relatively long. This is particularly a disadvantage if a customer has a shopping cart full of articles. On the other hand, the possibility of mistakes exists, wherein an article is put away without being (well) scanned.

Systems are also known wherein the articles, after scanning, are no longer located at the scan location but at a collecting location. In this type of systems, the articles are placed on a transport belt or the like in order to be transferred to a recognition station, and the articles, still by means of a transport belt or the like, are transferred from this recognition station to this collection location. For the customer, this means that in a first phase all articles must be placed on the transport belt, without the customer occupying himself with putting away or packing the articles. Almost immediately after placement on the transport belt, the article concerned is entered into the recognition station, and almost immediately after this, the article is delivered at the collection location. For the customer, this means that he can pay almost immediately after placing the last article on the transport belt, and that almost immediately after paying he can go to the collecting location in order to pick up his articles and put them away. The chance on mistakes, wherein an article is put away without being (well) scanned has reduced significantly in this case.

However, other problems occur in this case.

A problem of known automatic check-out systems is that the system can only be given free for a next customer after the previous customer has checked-out and packed his articles. As long as the customer is performing the payment operation, and as long as the customer is busy putting his articles away, no new articles can be transferred toward the collecting place. Herein, it is to be noted that, in comparison to manned check-out systems, in the case of automatic check-out systems it takes relatively long after payment before all articles have been put away.

Further, it is a disadvantage of known systems that the processed articles are lying in a collecting space without supervision, outside the view of the customer concerned, and that mistakes are possible wherein someone takes away articles from the wrong collecting space. The time duration between the moment of a first article entering the collecting space and the moment of the customer arriving at the collecting space can be relatively long.

Furthermore, automatic check-out systems which recognize the articles completely automatically are very complicated, especially in order to let the chance on failure of a recognition be as small as possible.

Thus, there is a need for a further improvement of automatic check-out systems.

An important aim of the present invention is to provide solutions to the said problems.

In an automatic check-out system proposed by the present invention the articles, after having been recognized, are transported to a secure collecting space via a secure traject. When all articles have been processed, the entrance to this collecting space is closed. This collecting space is given free for taking articles out only after the payment operation has been completed.

Preferably, a check-out system has two or more of those collecting spaces. Then, a next customer can directly proceed with delivering articles, even when the previous customer has not yet paid, which improves the efficiency of the system.

The collecting space can physically be closed by a flap or the like, which is given free after payment. It is also possible that the collecting space is provided with sensors which detect an unauthorized approach.

It is possible that a payment station is located by the collecting space. It is also possible that a payment station is located at the deliverance space, or even that there is a central payment station for multiple check-out systems, in which case a check-out slip is given with a release-code, for instance in the form of a barcode, which is then used at the collecting space for releasing the closure of the collecting space. The identification of the articles is primarily left to the customer, such that the complexity of full automatic check-out systems is not necessary here. After identification, for instance with a scanner, the customer must place the article on a transport belt or the like of a control station, which examines one or more control parameters of the article in relation to the entered identity of the article; preferably, this is a check on weight. From this recognition station, the articles, still by means of a transport belt or the like, are transferred to said collecting space.

These and other aspects, features and advantages of the present invention will be further clarified by the following description of a check-out system according to the present invention with reference to the drawings, in which same reference numerals indicate same or similar parts, and in which:

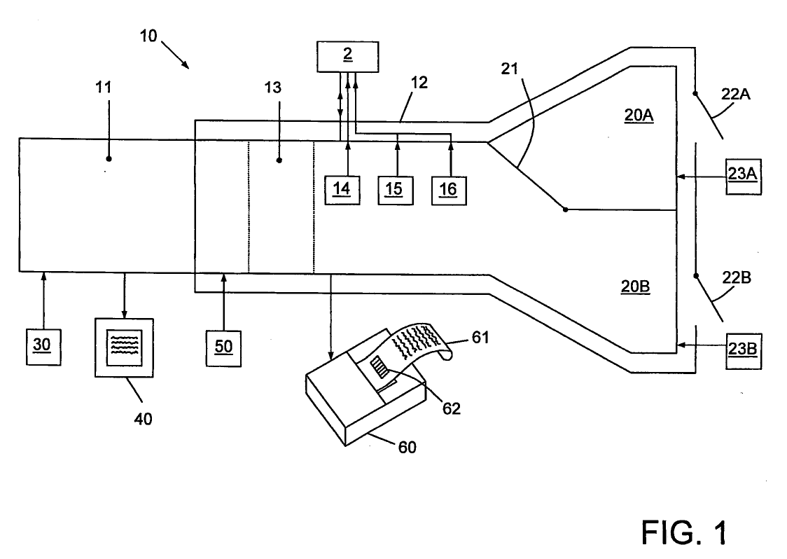

FIG. 1 schematically shows a top view of a check-out system according to the present invention.

FIG. 1 schematically shows a top view of a automatic check-out system 1 according to the present invention. The automatic check-out system 1 comprises a conveyor belt assembly 10 with a receiving part 11 accessible to a user. A user places articles on the receiving part 11 of the conveyor belt assembly 10, which articles are conveyed to a collecting space 20. The conveyor belt assembly 10 is shielded from the receiving part 11 to the collecting space 20, for instance by a hood 12, such that, beyond the receiving part 11, it is not possible to take articles away or to place articles.

Preferably, and as illustrated, the automatic check-out system 1 is provided with multiple collecting spaces; in the embodiment shown in FIG. 1, two of those collecting spaces are present, indicated as 20A and 20B.

The collecting space 20 is provided with a controllable access barrier 21, which is controlled by a control device 2. In the embodiment illustrated in FIG. 1, the two collecting spaces 20A and 20B have a common access barrier 21, implemented as a switchable guide which, in a first position, closes the first collecting space 20A and opens the second collecting space 20B, as shown, and which, in a second position, opens the first collecting space 20A and closes the second collecting space 20B.

In a first step, an article to be processed is to be recognized by the system. With this information, a supply system can be updated, but above all the price which the customer must pay for this article can be determined on the basis of this information. The automatic check-out system 1 can be a fully automatic check-out system, which is fully independently capable of recognizing articles. However, it is also possible that the automatic check-out system 1 is a semi-automatic check-out system, wherein the entering of article identification information is performed by the client by means of a data input unit 30. For this, there are several possibilities. The data input unit 30 can comprise a barcode reader, for instance a stationary mounted reader along which an article must be moved, or a hand-held reader which can be moved past the article, or both. The data input unit 30 also can comprise a numerical keyboard, for inputting the numerals corresponding to the barcode in situations that the barcode is not well readable.

For instance, a barcode reader comprises a scanner, which is adapted to scan the barcode of an article with a laser beam. Since such scanners are generally known and are usable in the implementation of the present invention, while further the present invention does not relate to improving such a scanner, the operation and design of a scanner will not be further discussed here. Suffice it to note that the barcode reading means have a signal output, where they provide a reading signal which is representative for the information which is stored in a recognized barcode. Preferably, this signal has already the form of one or more numerals, represented by a digital code. In any case, the signal provided is usable for a signal processing unit, such as the control unit 2, for looking up the desired data of the article concerned in an associated data file, including the price. It is even possible that the price itself is also encoded in the barcode.

The automatic check-out system 1 is provided with a display 40, with which the automatic check-out system 1 can communicate information to the user. For instance, a description of the article corresponding to the inputted code will be shown on the display, possibly with the associated price. On the basis of the information shown in the display, the customer can check whether the identification has taken place in a correct way, and if necessary he can press a reset button. Further, on the display a message can be shown that an inputted code is invalid or, if the code is valid, the customer can be asked to place the article on the receiving part 11.

If a valid identification code has been inputted, the article concerned is placed on the receiving part 11 of the conveyor belt assembly 10 by the customer in a second step.

Then, in a third step, a check is performed by the automatic check-out system 1, on the basis of the weight of the article. To this end, a part 13 of the conveyor belt assembly 10 is implemented as a weighing conveyor belt. Since weighing conveyor belts are known per se, it is not necessary here to give an elaborate description of the design and operation of the weighing conveyor belt 13. Suffice it to note that the weighing conveyor belt 13 provides to the control device 2 a signal which is representative for the weight of the article on the weighing conveyor belt 13.

The control device 2 compares the weight data coming from the weighing conveyor belt 13, which indicate the measured weight Gₘ, with an expected weight Gᵥ. This expected weight Gᵥ can be determined in several ways.

In the first place, it is possible that the weight is also incorporated in the barcode. In that case, the coded weight is taken as the expected weight. Usually, however, this will not be the case.

It is more practical if the weight data of the articles are also incorporated in said data file. This can be in the form of a single number which indicates the weight, or in the form of two numbers which indicate the limits of a weight range. Preferably, however, the weight data are incorporated in the form of statistical data such as average and variation or standard deviation.

The weight data can be inputted into the data file in several ways. In the first place, it is possible that the weight data corresponding to a certain barcode are predetermined and are inputted into the file in advance. In principle, this might even be done by hand. In that case, the values inputted once might be statistical numbers.

Preferably, however, the system is a self-learning system, and the weight data are dynamic numbers, which are constantly updated on the basis of actually measured weights Gₘ.

Now, it will be explained how, in relation to a certain article, for instance a carton of milk, the weight data are initially inputted in an input learning mode of the check-out system 1. In the usual way, the identification code of this article is communicated to the system (scanning of the barcode). Then a large number of representative specimens of the article concerned are weighed successively by the weighing conveyor belt 13 and the weights Gₘ are communicated to the control device 2, which calculates the mean value and the deviation. If all specimen have passed, the calculated numbers are stored into said data file. In principle, the said number can be as desired, but preferably this number is at least equal to ten.

This procedure can be repeated for other articles.

On the basis of the mean and deviation recorded in the data file, a range is determined inside which the measured weight should lie. This range can be calculated directly after the end of the input reading mode and can also be recorded into the data file, but this range may also be always calculated in a normal operating mode with respect to the article passing at that moment. For calculating said range, a certain tolerance factor t can be taken into account. The limits G1 and G2 of said range can than be calculated as
G1=G_{gem}−t×G_{dev}enG2=G_{gem}+t×G_{dev}
wherein G_{gem} is the mean of the measured weights, and wherein G_{dev} is the deviation of the measurements.

Said range, in fact, represents the expected weight Gᵥ earlier mentioned.

As already mentioned, the measured weight Gₘ is compared to the expected weight, i.e. the weight range [G1, G2], during the normal operating mode. If the measured weight Gₘ is not within this range, the control device 2 will find a error situation and will reject the article concerned. The article can now be conveyed to a separate output for rejected articles (not shown) or can be conveyed back towards the customer by means of a separate return belt or by driving the conveyor belt system 10 in reverse direction.

Further, it is possible that the control device 2 generates an alert signal in order to attract the attention of a service operator, in order for him/her to assess the situation so that he possibly may approve the article concerned after all.

In a possible embodiment, the system is static, which means to say that the stored article data G_{gem} and G_{dev}, and therefore also the limits G1 and G2, keep their value during the normal operating mode. Preferably, however, the system is dynamic, which means to say that the article data G_{gem} and G_{dev}, and therefore also the limits G1 and G2, are recalculated always when a specimen of the article in question is processed. In this case, the “oldest” measuring value is always replaced by the present one. To this end, the said data file has, for each article, N measuring value memory places, wherein N for instance is equal to 10. In the earlier-mentioned examples of cartons of milk, 10 cartons are initially measured, and their measured weights are stored in the measuring value memory places 1 to 10. The statistical data G_{gem} en G_{dev} are calculated on the basis of the values in these measuring value memory places. When now, during the normal operating mode, a carton of milk passes, the contents of place 1 is replaced by the contents of place 2, the contents of place 2 is replaced by the contents of place 3, etc, and the present measuring value is stored into place 10. It will be clear that a dynamic adaptation of the weight data to the recent measuring history is thus achieved.

This dynamic adaptation of the weight data to the present measuring weight Gₘ is executed only if the measured weight Gₘ lies within the currently valid weight range [G1, G2], and eventually also if the measured weight Gₘ lies outside the currently valid weight range [G1, G2] but is approved by a service operator.

In the case of articles priced per unit of weight, for instance vegetables or fruit, it is also possible that the bar code information only relates to the type of article, and possibly to the price per unit weight, and that the price to be paid is determined by the signal processing unit on the basis of the measured weight. In that case, in a first step a price per unit weight is communicated to the customer, and the article price is calculated by the control device 2 on the basis of the weight data of the weighing conveyor belt 13.

In a preferred embodiment, the automatic check-out system 1 is provided with further control means, for instance one or more cameras 14 arranged under the hood 12, with which it is possible to obtain a colour histogram, which is provided to the control device 2. In this case, also, the control device 2 will compare the colour histogram information with the data already known and, if there is no correspondence within certain margins, will find an error situation.

In a preferred embodiment, the automatic check-out system 1 is further provided with an RF receiving unit 15 arranged under the hood 12, which is suitable for detecting data of electronic tags of articles and to communicate these data to the control device 2. In this manner, a further check is possible for those articles which are provided with such tags.

In a further preferred embodiment, the automatic check-out system 1 is further provided with a detector 16 which can detect the speed of articles above the conveyor belt assembly 10. By using this detector 16, it is possible to detect an attempt to fraud, if someone wants to throw a not-identified article to the collecting space 20, without weighing detection by the weighing conveyor belt 13. It is assumed that the articles normally move with the same speed as the conveyor belt assembly 10. A possible falling article may have a speed which deviates from the speed of the conveyor belt assembly 10, but this deviation will lie within certain limits. If the control device 2 finds that an article is detected with a substantially larger speed, the control device 2 can enter an alarm condition, in which case the assistance is called of a service operator.

The above steps are repeated for each article. After the last article, the customer indicates that he is ready and that he wishes to pay. To that end, the data input unit 30 can be provided with a special READY-button. The control device 2 will now control the access barrier 21 to close the collecting space 20, such that no articles can be transported to the collecting space 20 anymore.

In a next step, the customer performs a payment act. To this end, the automatic check-out system 1 is preferably provided with a PIN payment machine 50, such that the customer can pay electronically by means of a payment card, credit card, or the like. The customer can read the total amount on the display 40. If the customer is not able or does not wish to pay electronically, he can pay cash at a separate cash register. Said PIN payment machine 50 can be arranged near the receiving part 11 or the conveyor belt assembly 10, but is preferably arranged just beyond this reception part 11, such that a next customer can already scan articles and place articles on the receiving part 11 of the conveyor belt assembly 10 while the previous customer is still busy with the payment act: the articles of the next customer are then conveyed to another collecting space 20.

After completion of the act of payment, the customer receives a cash slip 61 on which, besides the usual list of articles with their respective prices, a code 62 is printed. To this end, the automatic check-out system 1 is provided with a printer 60. The code 62 may for instance be printed in the form of readable numerals, or in the form of a barcode, or both.

Preferably, the automatic check-out system 1 is provided with a system which prevents that articles remain behind by mistake in the shopping cart without being registered by the automatic check-out system 1. In a possible embodiment, a camera is provided which detects the shopping cart at the moment that the customer operates the READY-button, or the moment that the customer moves away from the payment station, which camera is further provided with image recognition software which is capable of making a distinction between the image of an empty cart and the image of a cart with one or more articles in it. In another possible embodiment, it is prevented that shopping carts can pass the check-out, for instance by the presence of a tourniquet.

In a next step, the customer will collect his paid articles from the collecting space 20. This is not possible just like that, because the collecting space 20 is provided with a take away security 22 controllable by the control device 2, which prevents that articles are taken away from the collecting space 20 by unauthorized persons. In the embodiment illustrated, this security 22 is shown as a physical barrier, such as a flap, a door, or the like. However, it is also possible that this security 22 is implemented by a sensor, for instance a movement sensor, an approach sensor, etc. It is also possible that this security 22 is implemented by a weighing sensor associated with the collecting space 20 or a camera associated with the collecting space 20. Only the customer who has paid has a key to lift this security 22 in the form of the said release-code 62. An input unit 23 is arranged at the collecting space 20, for instance a numerical keyboard, a barcode reader, or both. Using the input unit 23, the customer inputs the code 62 of his cash slip received on payment; in response to receiving the correct code, the control device 2 controls the security 22 to lift the security 22. Now, the articles can be taken away from the collecting space 20.

In the meantime, the automatic check-out system 1 was available to a next customer, who could input his articles, in which case those articles were transported to another collecting space 20.

Thus, the present invention provides a check-out system 1 with an improved security against unauthorized taking away of articles. A customer inputs an identification code of an article, for instance by a scanner. The identification is checked by a weight measurement, and possibly with further measuring methods. The articles are conveyed to a shielded collecting space 20. When the customer is ready, an access barrier 21 of the collecting space 20 is closed. The customer can now pay, for instance with his PIN card. On the cash slip 61, he receives a release-code 62. This code is inputted with an input device 23 which is arranged near to the collecting space, after which a security 22 of the collecting space is lifted and the customer can take his articles away from the collecting space.

It will be clear to a person skilled in the art that the invention is not limited to the exemplary embodiments discussed in the above, but that several variations and modification are possible within the protective scope of the invention as defined in the attached claims.

In the embodiment shown, the collecting spaces 20 are shown as being arranged next to each other, perpendicular to the conveying direction of the conveying belt assembly 10. However, it is also possible that the collecting spaces 20 are arranged after each other, i.e. parallel to the conveying direction of the conveying belt assembly 10, with separate branches to subsequent collecting spaces.

Further, it is not necessary that the customer receives the release-code 62 printed on the cash slip 61; this code can also be given in a different manner, for instance printed on a separate ticket.

It is also possible for instance that the input unit 30 and the display 40 are integrated in a touch screen, on which information can be displayed and in which case choices or input can be inputted by touch; such screens are known per se.

It is also possible that a PIN pay automat is placed at every collecting space 20. This involves the costs of multiple payment automats but it saves the costs of multiple input units 23.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. Check-out system (1), comprising:
at least one collecting space (20);
a receiving part (11);
a conveyor belt assembly (10) from the receiving part (11) to the collecting space (20);
and a security (12; 21; 22) against taking articles away from the conveyor belt assembly (10) and from the collecting space (20).

17. Check-out system according to claim 16, wherein the security comprises a hood (12) extending from the receiving part (11) over the conveyor belt assembly (10).

18. Check-out system according to claim 16, wherein the security comprises a controllable access barrier (21) of the collecting space (20).

19. Check-out system according to claim 16, wherein the security comprises a controllable security (22) against taking articles away from the collecting space (20).

20. Check-out system according to claim 19, wherein the controllable security (22) comprises a controllable physical barrier.

21. Check-out system according to claim 20, wherein the controllable physical barrier is a flap.

22. Check-out system according to claim 20, wherein the controllable physical barrier is a door.

23. Check-out system according to claim 19, wherein the controllable security (22) comprises a sensor.

24. Check-out system according to claim 23, wherein the sensor is a movement sensor.

25. Check-out system according to claim 23, wherein the sensor is an approach sensor.

26. Check-out system according to claim 23, wherein the sensor is a camera.

27. Check-out system according to claim 16, further comprising an input unit (30) to be operated by a customer for inputting an article identification.

28. Check-out system according to claim 27, the input unit comprising a numerical keyboard.

29. Check-out system according to claim 27, the input unit comprising a barcode reader.

30. Check-out system according to claim 27, further comprising a weighing device (13) for weighing articles placed on the conveyor belt assembly (10).

31. Check-out system according claim 18, further comprising a control device (2) that is coupled to an input (30) and to the controllable access barrier (21) of the collecting space (20), which control device is designed to control the controllable access barrier (21) of the collecting space (20) to a closed condition in response to receiving a signal inputted by the customer indicating that the customer is ready.

32. Check-out system according to claim 19, further comprising a control device (2) that is coupled to the controllable security (22) of the collecting space (20), which control device is designed to control this security to a released condition after receiving a payment signal.

33. Check-out system according to claim 32, further comprising a cash slip printer (60), wherein the system is designed to print a cash slip (61) with a release-code (62) thereon when a customer has performed a payment.

34. Check-out system according to claim 32, further comprising an input unit (23) associated with the collecting space (20), coupled to the control device (2), wherein the control device (2) is designed to release said security in response to receiving a valid release-code (62).

35. Check-out system according to claim 30, further comprising a control device (2) and a data file associated therewith, which control device (2), in an input reading mode, is designed to measure weights of article specimen and to input these weights into the data file.

36. Check-out system according to claim 35, wherein the control device (2) is designed to calculate a mean (G_{gem}) and a deviation (G_{dev}) from the measured weights, and to store these data into the data file.

37. Check-out system according to claim 35, wherein the control device (2), in a normal operating mode, is designed to dynamically adapt the weight data in the data file to the presently measured weight (Gₘ).
